(19) United States
(12) Patent Application Publication
(10) Pub. No.: US 2007/0098993 A1
(43) Pub. Date: May 3, 2007

(54) ARTICLE WITH MULTILAYER DIAMOND-LIKE CARBON FILM

(75) Inventor: GA-LANE CHEN, Santa Clara, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,308

(22) Filed: Jul. 25, 2006

(30) Foreign Application Priority Data
Oct. 28, 2005 (TW) 094137941

(51) Int. Cl. B32B 9/00

(52) U.S. Cl. 428/408; 428/212

(57) ABSTRACT

An exemplary article includes a substrate and a multilayer diamond-like carbon film. The multilayer diamond-like carbon film includes a number of diamond-like carbon layers stacked one on another. Each diamond-like carbon layer is comprised of carbon, hydrogen and a metal-containing component selected from a group consisting of chromium, titanium, chromium-titanium alloy and chromium nitride. A content of the metal-containing component in each diamond-like carbon layer gradually decreases with increasing distance away from the substrate. The diamond-like carbon film with gradient composition and multilayer structure has better adhesion to substrate, better corrosion resistance and wear resistance, higher hardness and smoothness and longer lifetime.

### TECHNICAL FIELD

The present invention generally relates to diamond-like carbon films, and more particularly relates to an article with multilayer diamond-like carbon film having gradient composition.

### BACKGROUND

A diamond-like carbon film was first deposited by Aisenberg et al. Since this initial investigation of depositing the diamond-like carbon film, a variety of different techniques about the diamond-like carbon film have been developed.

Diamond-like carbon is a mostly metastable amorphous material but can include a microcrystalline phase. Diamond-like carbon contains both sp² and Sp³ hybridised carbon atoms. Diamond-like carbon includes amorphous carbon (a-C) and hydrogenated amorphous carbon (a−C:H) containing a significant Sp³ bonding. The amorphous carbon containing 85% or more of Sp³ bonding is called highly tetrahedral amorphous carbon (ta-C). The Sp³ bonding provides valuable diamond-like properties such as mechanical hardness, low friction, optical transparency and chemical inertness onto a diamond-like carbon film. The diamond-like carbon film has some advantages, such as being capable of deposition at room temperature, deposition onto steel or plastic substrates and superior surface smoothness.

Because of excellent properties such as corrosion resistance and wear resistance, the diamond-like carbon film is a suitable protective film material for various articles such as molds, cutting tools and hard disks. However, diamond-like carbon film also shows several drawbacks. One of the most serious practical problems is their poor adhesion to a substrate. This difficulty is caused by the high compressive stresses present in the diamond-like carbon film and the high compressive residual stresses present between the diamond-like carbon film and the substrate. Due to this problem, commercial application of the diamond-like carbon film is restricted to a certain extent.

What is needed, therefore, is an article with the multilayer diamond-like carbon film having good corrosion resistance, good wear resistance and high adhesion to substrate.

### SUMMARY

A preferred embodiment provides an article including a substrate and a multilayer diamond-like carbon film formed on the substrate. The multilayer diamond-like carbon film includes a number of diamond-like carbon layers stacked one on another. Each diamond-like carbon layer is comprised of carbon, hydrogen and a metal-containing component selected from a group consisting of chromium, titanium, chromium-titanium alloy and chromium nitride. A content of the metal-containing component in each diamond-like carbon layer gradually decreases with increasing distance away from the substrate.

### BRIEF DESCRIPTION OF THE DRAWINGS

Many aspects of embodiments can be better understood with reference to the following drawings. The components in the drawings are not necessarily drawn to scale, the emphasis instead being placed upon clearly illustrating the principles of the present embodiment. Moreover, in the drawings, like reference numerals designate corresponding parts throughout the several views.

FIG. 1 is a schematic view of a multilayer diamond-like carbon film formed on a substrate according to a preferred embodiment;

FIG. 2 is similar to FIG. 1, but showing a multilayer diamond-like carbon film formed on a substrate, with an intermediate layer interposed therebetween;

FIG. 3 is a schematic view of a multi-target co-sputtering system for forming a multilayer diamond-like carbon film according to a preferred embodiment; and

FIG. 4 is a top view of multi-target co-sputtering targets and rotation substrates of the multi-target co-sputtering system shown in FIG. 3.

### DETAILED DESCRIPTION OF PREFERRED EMBODIMENTS

Embodiments will now be described in detail below and with reference to the drawings.

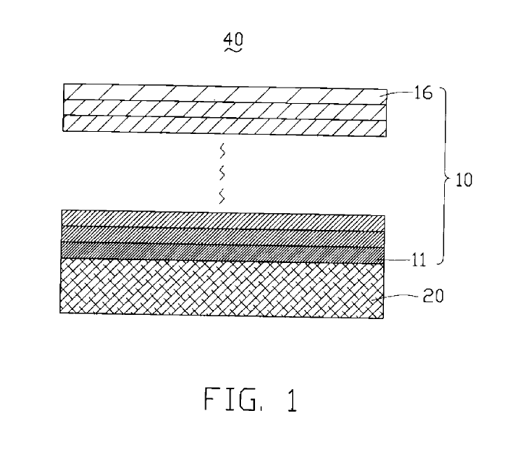

Referring to FIG. 1, an article 40 including the multilayer diamond-like carbon film 10 and a substrate 20 according to a preferred embodiment is shown. The multilayer diamond-like carbon film 10 is formed on the substrate 20. The article 40 can be a hard disk, a mold or a cutting tool. The substrate 20 can be magnetic media material or metal alloy such as sintered alloy, iron-based alloy, titanium-based alloy, aluminum-based alloy and copper-based alloy. The multilayer diamond-like carbon film 10 including a number of diamond-like carbon layers stacked one on another is shown. The diamond-like carbon layers have a gradient composition.

The multilayer diamond-like carbon film 10 is composed of n layers of diamond-like carbon layer, i.e. a first layer 11, a second layer 12, a third layer 13 . . . , a (n−2)th layer 14, a (n−1)th layer 15, and a nth layer 16 stacked one on top of the other in that order, wherein n is an integer, preferably in a range from 6 to 30. The first layer 11 is an innermost layer of the multilayer diamond-like carbon film 10 that is adapted to adhere to the substrate 20. The second layer 12 is a formed on the first layer 11, the third layer 13 is formed on the second layer 12, similarly, the (n−2)th layer 14 is the third layer counting from the outermost layer of the diamond-like carbon film 10 and is formed on the (n−3)th layer, the (n−1)th layer 15 is formed on the (n−2) layer 14, and a nth layer 16 is the outermost layer of the multilayer diamond-like carbon film 10. The nth layer 16 is formed on the (n−1)th layer 15 and is distant from the substrate 20.

Each diamond-like carbon layer has a different composition. Each diamond-like carbon layer is composed of carbon, hydrogen and a metal-containing component. The metal-containing component is selected from a group consisting of chromium, titanium, chromium-titanium alloy and chromium nitride. The metal-containing component in each diamond-like carbon layer gradually decreases in content from the first layer 11 to the nth layer 16. For example, if an mth layer is any one of the diamond-like carbon layers of the multilayer diamond-like carbon film 10, a composition of the mth layer can be represented by a formula of a−C:H:(n−m+1)X, wherein m is an integer in a range from 1 to n, C represents a carbon component, H represents a hydrogen component, and X represents a metal-containing component. Therefore, the composition of each diamond-like carbon layer can be represented by a concrete formula. For example, the first layer 11 is represented by a−C:H:nX, the second layer 12 is represented by a formula of a−C:H:(n−1)X, the third layer 13 is represented by a−C:H:(n−2)X . . . , the (n−1)th layer 15 is represented by a−C:H:3X, the (n−1)th layer 15 is represented by a−C:H:2X, and the nth layer 16 is represented by a−C:H:X. A content of the metal-containing component in each diamond-like carbon layer is in a range from 0.2% to 1.0%.

Accordingly, the first layer 111 has greatest atomic percentage of the metal-containing component and the nth layer 16 has least atomic percentage of metal-containing component. The metal-containing component can enhance strength of the diamond-like carbon layer, whilst the corrosion resistance and wear resistance of the diamond-like carbon layer are weakened. Therefore, the properties of each diamond-like carbon layer depend on the atomic percentage of the metal-containing component thereof.

The first layer 11 is the innermost layer of the multilayer diamond-like carbon film 10 that is adapted to contact with the substrate 20. The substrate 20 is usually made of a metal material, thus, an increased content of the metal-containing component in the first layer 111 of multilayer diamond-like carbon film 10 facilitates an adhesion to the substrate 20. In other words, the multilayer diamond-like carbon film 10 adheres relatively easily to the substrate 20.

The nth layer 16 is the outermost layer of multilayer diamond-like carbon film 10. That the nth layer 16 has the least atomic percentage of the metal-containing component enhances its properties, such as hardness, corrosion resistance and wear resistance, smoothness, etc.

The atomic percentage of the metal-containing component in each layer of the multilayer diamond-like carbon film 10 gradually decreases from the first layer 111 to the nth layer 16. For example, the atomic percentage of the metal-containing component in the first layer 111 is 1%. The atomic percentage of the metal-containing component in the nth layer 16 is 0.2%. The atomic percentage of the metal-containing component in other layers is gradually reduced from 1% to 0.2%.

A thickness of each diamond-like carbon layer of the multilayer diamond-like carbon film 10 is in a range from 0.1 nanometers to 30 nanometers. A thickness of the multilayer diamond-like carbon film 10 is in a range from 0.6 to 900 nanometers.

In one example, the substrate 20 is magnetic media material of a hard disk, the each diamond-like carbon layer thickness is in a range from 0.2 nanometers to 0.5 nanometer and the thickness of the multilayer diamond-like carbon film 10 is a range from 1.2 nanometers to 15 nanometers. Preferably, a thickness of the multilayer diamond-like carbon film 10 is a range from 1.5 nanometers to 3 nanometers. The thinner multilayer diamond-like carbon film 10 gives better magnetic recording performance.

In another example, the substrate 20 is metal alloy of a mold or a cutting tool, the each diamond-like carbon layer thickness is in a range from 1 nanometer to 30 nanometers and a thickness of the multilayer diamond-like carbon film 10 is in a range from 6 nanometers to 900 nanometers. Preferably, a thickness of the multilayer diamond-like carbon film 10 is a range from 30 nanometers to 450 nanometers.

The multilayer diamond-like carbon film 10 may have good performance of corrosion resistance, adhesion, and wear resistance by optimizing the gradient composition and multilayer structure. The multilayer diamond-like carbon film 10 with good corrosion resistance, good wear resistance and high adhesion to the substrate 20 can be served as thin protective film on articles 40 such as molds, cutting tools and hard disks.

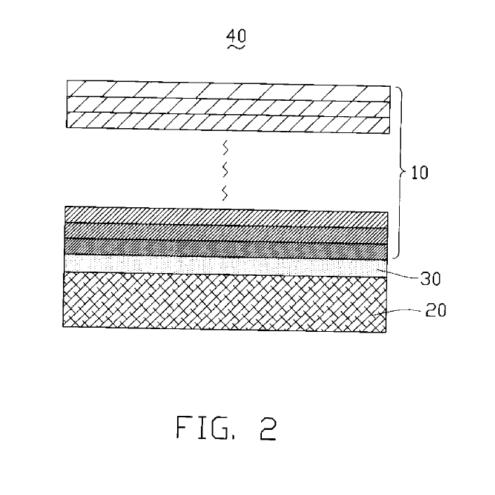

Referring to FIG. 2, the multilayer diamond-like carbon film 10 formed on the substrate 20 with an intermediate layer 30 sandwiched therebetween is shown.

The intermediate layer 30 is formed on the substrate 20 and serves as a functional layer. The material of the intermediate layer 30 is selected according to the material used for the substrate 20. For example, when the substrate 20 is magnetic media material of hard disks, the intermediate layer 30 can be a magnetic layer such as cobalt-chromium-tantalum (CoCrTa) alloy and cobalt-chromium-platinum-tantalum (CoCrPtTa) alloy. If the substrate 20 is metal alloy of molds or cutting tools, the intermediate layer 30 is a mirror-polished layer with composition such as ferrum-chromium-carbon-molybdenum-silicon-vanadium (FeCrCMoSiV) alloy. The intermediate layer 30 is bonded to the multilayer diamond-like carbon film 10 and the substrate 20 via metallic bonding. Thus the multilayer diamond-like carbon film 10 has higher adhesion to the substrate 20.

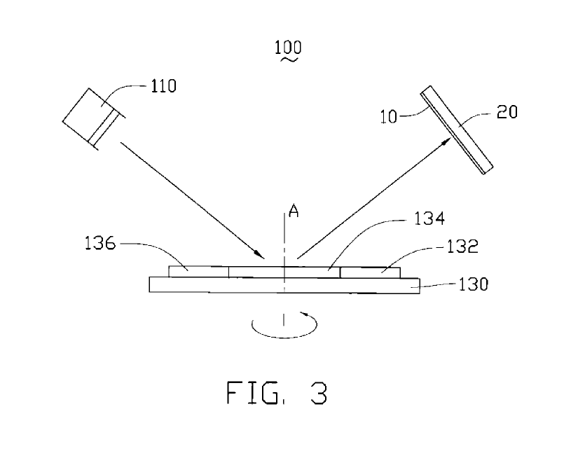

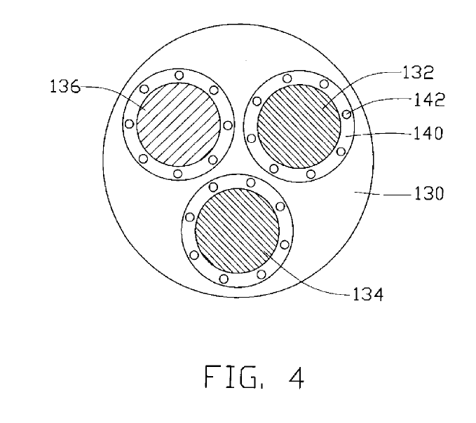

The multilayer diamond-like carbon film 10 can be deposited using a co-sputtering process. Referring to FIG. 3 and FIG. 4, a multi-target co-sputtering system 100 for forming a multilayer diamond-like carbon film 10 according to the preferred embodiment is shown. The multi-target co-sputtering system 100 includes an ion source 110 and a rotating stage 130. The ion source 110 is used to disassociate and ionize a sputter gas to generate reactive plasma. The rotating stage 130 has a rotational axis A and three targets. The rotating stage 130 can turn around the rotational axis A. The first target 132 and the second target 134 are carbon targets, and the third target 136 is a metal-containing material target. The metal-containing material can be selected from a group consisting of chromium, titanium, chromium-titanium alloy and chromium nitride. Each target has a ring 140 with lots of diffusion holes 142 around an exterior edge thereof. The diffusion holes 142 can let the sputter gas to go surrounding each target to form reactive plasma for sputtering deposition the multilayer diamond-like carbon film 10 on the substrate 20.

During the co-sputtering process, the multilayer diamond-like carbon film 10 is deposited on the substrate 20 in a vacuum environment. The sputter gas is introduced into the multi-target co-sputtering system 100 to maintain a sputter pressure in a range from 0.6 torrs to 5 torrs. The sputter gas for the first target 132 and the second target 133 can be selected from a group consisting of a mixture of argon and methane (with a percentage by volume of methane in a range from 5% to 20%), a mixture of argon and hydrogen (with a percentage by volume of hydrogen in a range from 5% to 20%), a mixture of argon and ethane (with a percentage by volume of ethane in a range from 5% to 20%), a mixture of krypton and methane (with a percentage by volume of methane in a range from 5% to 20%), a mixture of krypton and hydrogen (with a percentage by volume of hydrogen in a range from 5% to 20%), and the mixture of krypton and ethane (with a percentage by volume of ethane in a range from 5% to 20%). The sputter gas surrounds the first target 132 and the second target 134. The ion source 110 energizes the sputter gas to form reactive plasma for sputtering deposition of carbon and hydrogen. The sputter gas for the third target 136 can be selected from a group consisting of argon, and a mixture of argon and nitrogen (with a percentage by volume of nitrogen in a range from 3% to 15%). The sputter gas also surrounds the third target 136 to form reactive plasma for sputtering deposition on metal.

Multi-target co-sputtering process allows a multilayer structure to form by adjusting the deposition parameters, such as sputter pressure, sputter temperature, substrate bias, and the sputter gas ratio. Each diamond-like carbon layer of multilayer diamond-like carbon film 10 can be deposited by controlling the deposition parameters. After depositing n layers, the multilayer diamond-like carbon film 10 with gradient composition and multilayer structure is formed on the substrate 20. The multilayer diamond-like carbon film 10 with gradient composition and multilayer structure has better adhesion, better corrosion resistance and wear resistance, higher hardness and smoothness and longer lifetime.

Additionally, before forming the multilayer diamond-like carbon film 10, the intermediate layer 30 is formed on the substrate 20 in order to further enhance the adhesion. The intermediate layer 30 can be formed using a method such as direct current (DC) magnetron sputtering, alternating current (AC) magnetron sputtering, and radio frequency (RF) magnetron sputtering.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. An article, comprising
a substrate; and
a multilayer diamond-like carbon film formed on the substrate; the multilayer diamond-like carbon film comprising a plurality of diamond-like carbon layers stacked one on another, each diamond-like carbon layer being comprised of carbon, hydrogen and a metal-containing component selected from a group consisting of chromium, titanium, chromium-titanium alloy and chromium nitride; a content of the metal-containing component in each diamond-like carbon layer gradually decreasing with increasing distance away from the substrate.

2. The article as claimed in claim 1, wherein the multilayer diamond-like carbon film comprises an innermost layer configured to adhere to a substrate and an outermost layer distant from the innermost layer, with the other layers sandwiched between the innermost layer and the outermost layer; the content of the metal-containing component gradually decreasing from the outermost layer to the innermost layer.

3. The article as claimed in claim 1, wherein the substrate is comprised of a material selected from a group consisting of magnetic media material and metal alloy.

4. The article as claimed in claim 1, wherein a number of the diamond-like carbon layers is in a range from 6 to 30.

5. The article as claimed in claim 12, wherein an atomic percentage of the metal-containing component in each diamond-like carbon layer is in a range from 0.2% to 1%.

6. The article as claimed in claim 1, wherein a thickness of each diamond-like carbon layer is in a range from 0.1 nanometers to 30 nanometers.

7. The article as claimed in claim 6, wherein the thickness of each diamond-like carbon layer is in a range from 0.2 nanometers to 0.5 nanometers.

8. The article as claimed in claim 6, wherein the thickness of each diamond-like carbon layer is in a range from 1 nanometer to 30 nanometers.

9. The article as claimed in claim 1, wherein a thickness of the multilayer diamond-like carbon film is in a range from 0.6 nanometers to 900 nanometers.

10. The article as claimed in claim 9, wherein the thickness of the multilayer diamond-like carbon film is in a range from 1.2 nanometers to 15 nanometers.

11. The article as claimed in claim 10, wherein the thickness of the multilayer diamond-like carbon film is in a range from 1.5 nanometers to 3 nanometers.

12. The article as claimed in claim 9, wherein the thickness of the multilayer diamond-like carbon film is in a range from 30 nanometers to 450 nanometers.

13. The article as claimed in claim 1 further comprising an intermediate layer sandwiched between the substrate and the multilayer diamond-like carbon film.
